(19) United States
(12) Patent Application Publication
(10) Pub. No.: US 2013/0220283 A1
(43) Pub. Date: Aug. 29, 2013

(54) DUAL SOLENOID FUEL INJECTOR WITH SELECTIVELY ACTUABLE INPUT AND OUTPUT VALVES

(71) Applicant: Transonic Combustion, Inc., (US)

(72) Inventors: Michael C. Cheiky, Thousand Oaks, CA (US); David L. Grottenthaler, Camarillo, CA (US)

(73) Assignee: Transonic Combustion, Inc., Camarillo, CA (US)

(21) Appl. No.: 13/772,636

(22) Filed: Feb. 21, 2013

Related U.S. Application Data
(62) Division of application No. 12/612,440, filed on Nov. 4, 2009.
(60) Provisional application No. 61/117,897, filed on Nov. 25, 2008.

(51) Int. Cl. F02M 53/06; F02M 63/00

(52) U.S. Cl. CPC F02M 53/06; F02M 63/0007
USPC 123/557; 239/132; 239/585.1

(57) ABSTRACT

The present invention provides a fuel injector for an internal combustion engine. The fuel injector comprises a housing with an injector stem positioned inside the housing such that the injector stem comprises lower and upper portions. A first fluid chamber is located at the lower portion and a second fluid chamber is located at the upper portion with a seal positioned between the fuel chambers. A fuel duct is connected to the first fluid chamber and input and output ducts are connected to the second fluid chamber to allow fuel to fill and drain from the second fluid chamber. A first valve attached to the input duct and a second valve attached to the output duct are selectively actuable to open and close. The fuel injector further comprises a spring biasing the injector to a closed position, a heating element and a controller element.

### CROSS-REFERENCE TO RELATED APPLICATIONS

This application is a divisional of U.S. application Ser. No. 12/612,440, filed on Nov. 4, 2009 which claims priority to U.S. Provisional Patent Application No. 61/117,897, filed Nov. 25, 2008. The contents of U.S. application Ser. No. 12/612,440 and U.S. Provisional Patent Application No. 61/117,897 are hereby incorporated herein in their entirety by reference, including the drawings, charts, schematics, diagrams and related written description.

### FIELD OF THE INVENTION

The invention broadly relates to fuel injection systems and more particularly to an injector-ignition fuel injector for an internal combustion engine that is heated and catalyzed with a catalytic activator section.

### BACKGROUND OF THE INVENTION

Much of the world's energy consumption is dedicated to powering internal combustion based vehicles. Most gasoline and diesel car engines are only 20-30% efficient, such that a major portion of the hydrocarbon fuels is wasted, thereby depleting global resources while producing an excessive quantity of pollutants and greenhouse gasses. As illustrated in FIG. 1 (prior art), about one third of the energy used by a conventional engine manifests itself as waste heat in the cooling system (coolant load 4) while another approximately one third of the energy goes out the tailpipe (exhaust enthalpy 2) leaving one third or less to provide useful work (brake power 6). At the internal level, these inefficiencies are due to the fact that the conventional combustion process inside a spark ignition gasoline engine or compression ignition diesel engine takes far too long as compared to the rotational dynamics of the piston and crank (i.e., the power stroke of the engine).

Conventional fuel injectors can have hydraulically actuated injector pins. The injector pins are typically biased in one direction, either open or closed, by a resilient element, such as a spring. In such injectors, fuel pressure is used to open or close the injector pin against the force of the resilient element. Typically, a fuel injector using a hydraulically actuated injector pin operates by allowing pressurized fuel on opposite sides of the injector pin. The fuel remains separated on the opposite sides by a sealing mechanism. Because the pressurized fuel on both sides of the injector pin are at equilibrium pressure, the inherent force exerted by the spring holds the pin in a closed position. In order to actuate the pin to open against the spring force, the pressurized fuel is drained from one side of the injector pin, thereby causing the remaining pressurized fuel on the other side of the sealing mechanism to push against the biasing of the spring and in turn move the injector pin to an open position.

### SUMMARY OF THE INVENTION

The present invention is directed towards a fuel injector having a hydraulically actuated injection pin, also known as an injector stem. In accordance with the invention, the fuel injector provides for more efficient fuel combustion within internal combustion engines, such as vehicle engines. The fuel injector may operate on a wide range of liquid fuels including gasoline, diesel, and various bio-fuels. According to various embodiments of the invention, the fuel injector achieves efficient fuel combustion by fast and responsive actuation, heating the fuel to a supercritical temperature, maintaining fuel at a supercritical pressure, and using a catalyst in the oxidization of the fuel.

One embodiment of the invention involves a fuel injector apparatus for an internal combustion engine, such as a vehicle engine, comprising a housing with an upper and lower portion, which contains an injector stem. Typically, the injector stem comprises a lower portion and an upper portion. These assemblies are also referred to herein as the lower injector stem assembly and an upper injector stem assembly. The lower injector stem assembly includes the injector pin, which contacts a seating surface when closed to prevent fuel from entering the combustion chamber of the vehicle engine. The upper and lower injector stem assemblies are attached to each other using conventional methods, e.g., brazing.

Within the lower portion of the housing and positioned at the lower injector stem is a first fluid chamber, which is configured to receive pressurized fuel through a fuel duct connected to the first fluid chamber. A second fluid chamber, which is within the upper portion of the housing and positioned at an upper portion of the injector stem, is configured to receive pressurized fuel through an input duct connected to the second fluid chamber. Additionally, an output duct connected to the second fluid chamber allows for fuel drainage from the second fluid chamber. A seal between the first and second fluid chambers separates the fuel within the two chambers.

A first valve attached to the input duct is configured to selectively open and close the input duct through actuation, thereby controlling the flow of pressurized fuel into the second fluid chamber. Fuel drainage from the second fluid chamber, in turn, is controlled by an orifice needle hole positioned within the output duct. In some alternative embodiments, a first valve is attached to the output duct and is configured to selectively open and close the output duct through actuation, thereby controlling the flow of fuel drainage from the second fluid chamber. In such embodiments, pressurized fuel flow into the second fluid chamber is controlled by an orifice needle hole positioned within the input duct. In yet other alternative embodiments, a first valve is attached to the input duct and a second valve is attached to the output duct, thereby replacing the use of an orifice needle hole.

Attached to the injector stem is a return spring that biases the injector stem to a closed position. In some embodiments of the invention, the return spring is attached to the upper portion of the injector stem. In additional embodiments, the fuel injector is in the closed position when the injector stem is forced downward and, hence, the return spring biases the injector stem downward so that the injector pin is in contact with the injector seat.

The first fluid chamber also has a heating element positioned adjacent to the chamber. As such, the heating element is capable of heating up the fuel within the first fluid chamber before it is injected into the combustion chamber of the internal combustion engine.

A controller connected to the heating element controls the engagement of the element. The controller is connected to the first valve for selective actuation of the first valve. Further, in embodiments of the invention that utilize a second valve, the controller is also connected to the second vale for the selective actuation of the second valve.

In some embodiments, a catalyst is included in the inner sidewall of the first fluid chamber. In some alternative embodiments, a catalyst is attached to the lower portion of the injector stem. Usually, when the catalyst is attached to the lower portion of the injector stem, the catalytic element is applied to the outer surface of the lower portion of the injector stem. Generally, one of the purposes served by the catalysts is to assist in the oxidation of fuel before it enters the combustion chamber of the internal combustion engine. Some embodiments of the invention feature only one of the surfaces (either the inner sidewall of first fluid chamber or the outer surface of lower portion of the injector stem) being coated with the catalytic element. In other embodiments, both surfaces are coated with the catalytic element.

In other embodiments of the invention, an electromechanical valve is used as the first valve. Similarly, various embodiments use an electromechanical valve as the second valve. The use of electromechanical valve allows fast filling and draining of the first fluid chamber. In some embodiments that employ electromechanical valves, these valves comprise solenoids. The solenoid is connected and controlled by the controller described above.

In some embodiments, a proximity sensor can be positioned in the upper portion of the housing to monitor the position of the injector stem. This proximity sensor is connected to the controller.

In preferred embodiments, the fuel within first fluid chamber is maintained at a supercritical state. Specifically, in some such embodiments, the fuel is maintained in at either a supercritical temperature, a supercritical pressure, or both. Generally, maintaining fuel at a supercritical state before it is injected into the combustion chamber of the internal combustion engine yields more efficient combustion of the fuel. In some embodiments, fuel within the first fluid chamber is maintained at a supercritical temperature vis-a-vis the heating element. In other embodiments, fuel within the first fluid chamber is maintained at a supercritical pressure by the injector stem and the fuel duct.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 (prior art) is a diagram that illustrates the inefficiencies in a conventional combustion process inside a spark ignition gasoline engine or a compression ignition diesel engine.

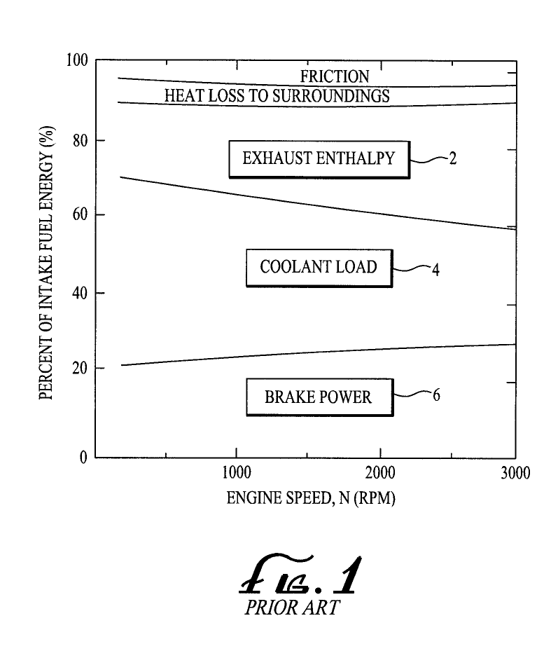

FIG. 2 depicts a cross section of a dual solenoid fuel injector constructed in accordance with the principles of the present invention.

FIG. 3 depicts a cross section of the upper portion of a dual solenoid fuel injector constructed in accordance with the principles of the present invention.

FIG. 4 depicts a cross section of the lower portion of a dual solenoid fuel injector constructed in accordance with the principles of the present invention.

FIG. 5 depicts a front perspective view of a dual solenoid fuel injector constructed in accordance with principles of the present invention.

FIG. 6 depicts a front view of a dual solenoid fuel injector constructed in accordance with principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In accordance with the principles of the present invention, an internal combustion engine fuel injector having a hydraulically actuated injection pin, also referred to herein as an injector stem, is provided. According to various embodiments of the invention, the fuel injector achieves efficient fuel combustion by (i) fast and responsive actuation, (ii) heating the fuel to a supercritical temperature, (iii) maintaining the fuel at a supercritical pressure, and (iv) using a catalyst in the oxidization of the fuel before it enters the combustion chamber of the internal combustion engine. The fuel injector may operate on a wide range of liquid fuels including gasoline, diesel, and various bio-fuels.

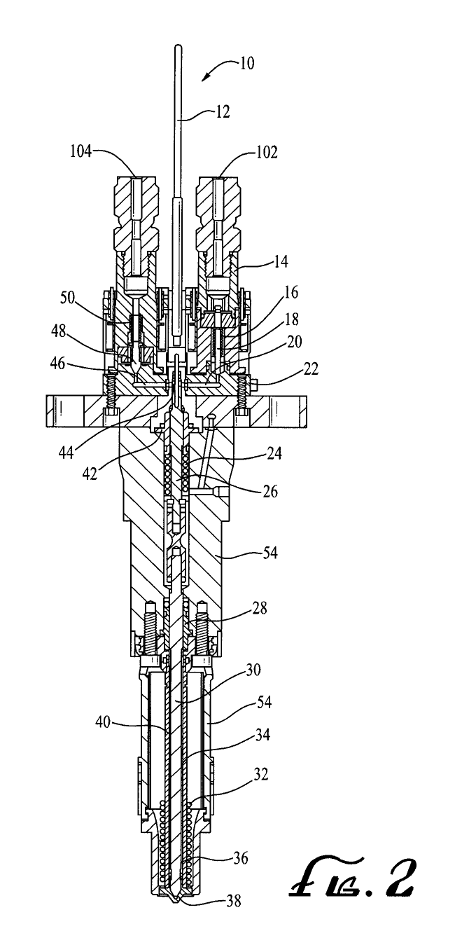

In accordance with the present invention, the fuel injector 10 depicted in FIG. 2-4 comprises two electromechanical valves (14 and 52), a heating element 32, and a catalyst material within a lower fluid chamber 36.

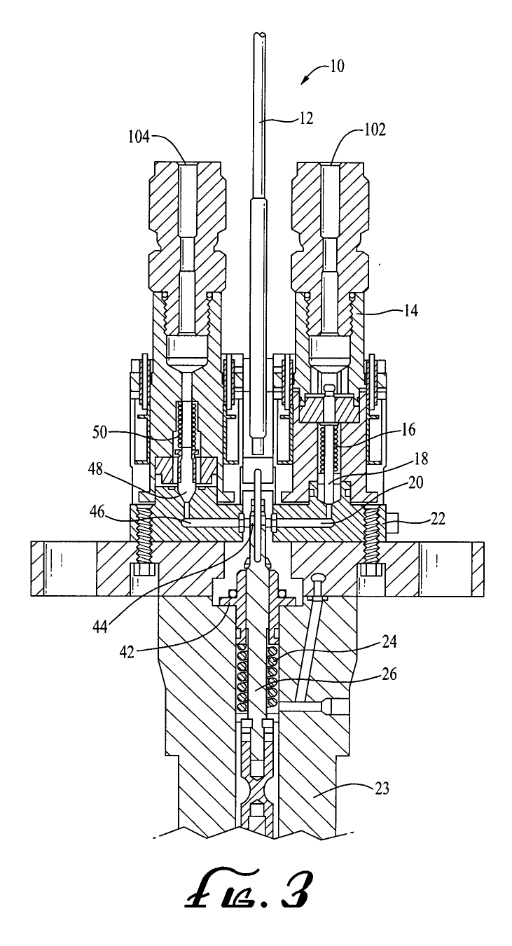

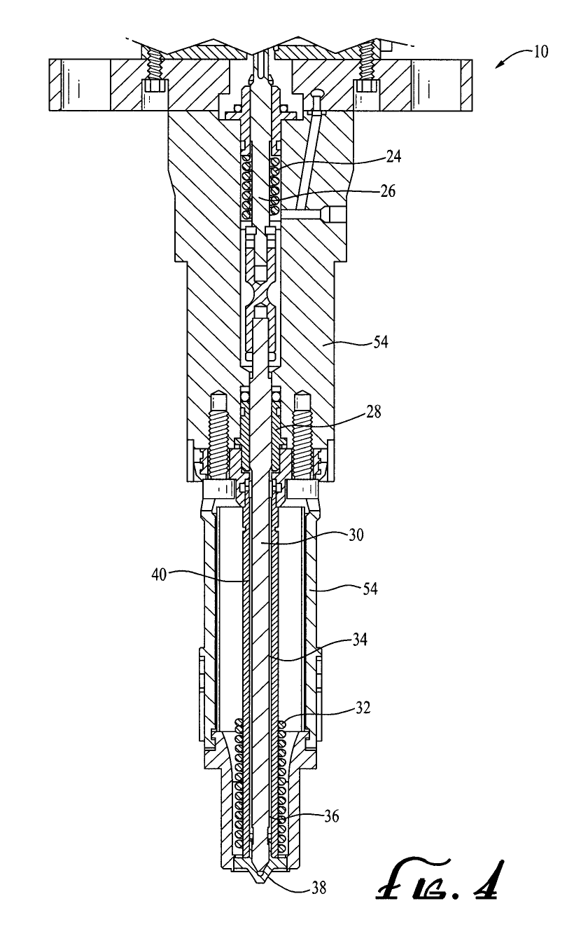

More particularly, FIG. 2 depicts a cross section of the fuel injector 10 constructed in accordance with the principles of the present invention. An enlarged view of the upper portion of the fuel injector 10 is provided in FIG. 3, while an enlarged view of the lower portion of the fuel injector 10 is provided in FIG. 4.

Referring to FIG. 2, the fuel injector 10 has a lower housing 54 connected to an upper housing 22. Usually, the lower housing 54 and upper housing 22 are connected to each other by bolts extending through the housing bodies. The lower housing 54 (also referred to as outer housing 54) is concentric and coaxial with an inner housing 40.

Now referring to FIG. 4, the lower housing 54 is typically made of stainless steel, however, any appropriate metal can be used. The outer housing 54 has a lower portion having an injector seat 38. The injector seat 38 is the inner surface of an orifice that allows for fuel to exit the fuel injector 10 into the combustion chamber of an internal combustion engine. While some embodiments of the invention have only one orifice leading out of the fuel injector, other embodiments can have a plurality of such orifices.

With further reference to FIG. 4, inner housing is positioned concentrically within the outer housing 54. The inner housing 40 has a hollow inner cavity and an inner surface 34. The inner surface 34 allows for the sliding movement of the injector stem assembly, comprising an upper stem 26 and a lower stem 30. Although the diameter of the hollow inner cavity can be any desired value, in some preferred embodiments of the invention the diameter is about 4 mm. At the bottom of the hollow inner cavity is the lower fluid chamber 36, from which fuel exits the fuel injector 10 during operation. The lower fluid chamber 36 is adjacent to the injector seat 38 and is formed between the lower stem 30 and the inner housing 40. The lower fluid chamber 36 is connected to an input port that allows for pressurized fuel to be delivered into the lower fluid chamber 36.

With continued reference to FIG. 4, the lower stem assembly 30 and the inner surface 34 of the inner housing 40 form a seal to prevent fluid within the lower fluid chamber 36, which is below the lower stem 30, from contacting or mixing with fluid from the upper stem assembly 26. Any appropriate sealing mechanism 28, such as precision ground seals, bellows seals, o-ring seals, diaphragm, elastomers, or energized seals, may be employed to prevent fluid within the lower fluid chamber 36 from contacting with fluid from the upper stem assembly 26.

In preferred embodiments, the inner housing 40 adjacent the lower fluid chamber contains a heating element 32. The heating element 32 can be a resistance coil or any other suitable means to allow for the selective heating of the inner surface of the inner housing 40. The heating element 32 allows for the fuel in the lower fluid chamber 36 to be heated to a temperature of 600 degrees Fahrenheit to 1300 degrees Fahrenheit, allowing the fuel to reach a supercritical temperature that allows for more efficient combustion. The heating element 32 extends from the injector seat 38 to the top of the lower portion of the lower stem 30 to form a consistent heating of the entire lower fluid chamber 36.

In additional preferred embodiments, a catalyst element is included in the lower fluid chamber 36. In some of these embodiments, the catalyst element can be a coating, plating, surface treatment, wire winding or bonding that is coated on, attached to, or formed integrally with the lower stem 30, the inner surface 34 of the inner housing 40, or both. In a specific preferred embodiment, the catalyst element forms part of the outer surface of the lower stem 30. The catalyst element can also be formed on a portion of the inner wall of the inner housing 40 adjacent the lower fluid chamber 36. Forming the catalyst on either surface allows for the fuel contained in the lower fluid chamber to react with the catalyst before it enters the combustion chamber, allowing for a more efficient burning of the fuel. Preferably, the catalyst is nickel with about 5% molybdenum, however, a person of ordinary skill in the art would appreciate that a number of appropriate catalysts can be used, such as nickel, nickel-molybdenum, alpha alumina, aluminum silicon dioxide, other air electrode oxygen reduction catalysts, and other catalysts used for hydrocarbon cracking.

With reference to FIG. 2, an injector stem 26, 30 is depicted along the centerline of the fuel injector 10. The injector stem (also referred to as the injector stem assembly 26, 30) is housed within the lower housing 54. As previously noted, the injector stem 26, 30 comprises an upper stem 26 and lower stem 30, wherein the upper injector stem 26 and lower injector stem assembly 30 are attached to each other. Some embodiments of the invention use brazing as the method for attaching the upper stem 26 to the lower stem 30. A person of ordinary skill in the art would appreciate that there are other suitable methods for attachment, without departing from the scope of the invention. Additionally, a proximity sensor 12 is positioned in the upper housing 22 allowing for sensing of the current position of the stem assembly.

With resumed reference to FIG. 4, the bottom end of lower stem 30 is configured with a double angled surface such that when the fuel injector 10 is in the closed position, the double angled surface makes contact with the injector seat 38. When the double angled surface makes contact with the injector seat 38, a fluid tight seal is formed, preventing any fuel in the lower fluid chamber 36 from escaping through the orifice leading out of the fuel injector.

Referring now to FIG. 3, a return spring assembly 24 is positioned at the upper stem 26 and configured such that the force the spring 24 exerts against flange 42 forces the upper stem 26 in downward direction. With the upper stem 26 forced downward, the lower stem 30 is also forced downward, causing the double angled surface of the lower stem 30 to make contact with the injector seat 38. As previously noted, when the double angled surface makes contact with the injector seat 38, a fluid tight seal is formed, preventing any fuel in the lower fluid chamber 36 from escaping the fuel injector 10 and entering the combustion chamber of the internal combustion engine. Those of ordinary skill in the art would appreciate that the return spring assembly 24 could be substituted using any suitable biasing element.

Continuing reference to FIG. 3, the fuel injector 10 includes a pilot valve assembly (14 and 52) that controls the hydraulic pressure acting on the upper stem assembly 26. The hydraulic pressure, in turn, is used to lift and lower the entire injection steam assembly, thereby lifting and lowering the double angled surface of the lower stem 30 that makes contact with the injector seat 38. More specifically, an upper fluid chamber 44, that is part of the pilot valve assembly (14 and 52), provides the hydraulic pressure on the upper stem 26 in the form of pressurized fuel. The upper fluid chamber 44 is configured for fuel to be contained therein at a pressure which is substantially equal to the pressure of the lower fluid chamber 36. To facilitate this, the upper chamber 44 has an inlet duct 20 that allows for a constant flow of fuel to be pumped into the chamber 44. An outlet duct 46 is also provided for the upper fluid chamber 44, allowing for the upper fluid chamber 44 to be drained and the fuel to be returned to the fuel reservoir or tank.

With continued reference to FIG. 3, fuel I provided to the inlet duct 20 via input duct 102. Likewise, fuel is drained through the outlet duct 46 into output duct 104, which returns the fuel to a reservoir or tank. The illustrated fuel injector 10 has an input electromechanical valve 14 for controlling the flow of fuel to the upper chamber 44, and an output electromechanical valve 52 for controlling the flow of fuel out of the upper chamber 44. The input electromechanical valve 14 is connected to a poppet valve 18 and has a spring 16 that biases the poppet valve into a normally open position, thereby allowing fuel into the upper chamber 44. Output electromechanical valve 52 is connected to a poppet valve 48 with a spring 50 that biases the poppet valve 52 into a normally closed position, thereby preventing fuel from draining from the upper fluid chamber 44. The respective position of the poppet valves (18 and 48) are reversed when their respective electromechanical valve is activated. Hence, when the upper fluid chamber 44 needs to be filled, the input electromechanical valve 14 and output mechanical valve 52 are deactivated. When the upper fluid chamber 44 needs to be drained, both the input electromechanical valve 14 and output mechanical valve 52 are activated. The specific type of electromechanical valve used in the depicted fuel injector 10 is a solenoid. The input solenoid 14 is positioned in fluid connection with a fuel inlet duct 20, and the output solenoid 52 is positioned in fluid connection with the outlet duct 46. Each solenoid is connected to a controller that controls solenoid actuation.

In some embodiments of the invention, an orifice needle hole is positioned in the input duct 102 and used to control the flow of fuel into the input duct 102, while an electromechanical valve is positioned in fluid connection with the outlet duct 104 and controls the flow of drainage from the upper fluid chamber 44. In alternative embodiments of the invention, an orifice needle hole is positioned in the output duct 104 and used to control the flow of fuel out of the output duct 104, while an electromechanical valve is positioned in fluid connection with the input duct 102 and controls the flow of fuel into the upper fluid chamber 44.

Although FIG. 2-6 depict a fuel injector using dual solenoid actuators in accordance with the present invention, a person of ordinary skill in the art would appreciate that any type of actuator can be used to control the poppet valves (18 and 48). For example, in alternative embodiments of the invention, piezo elements can be used in place of the solenoid actuators (14 and 52).

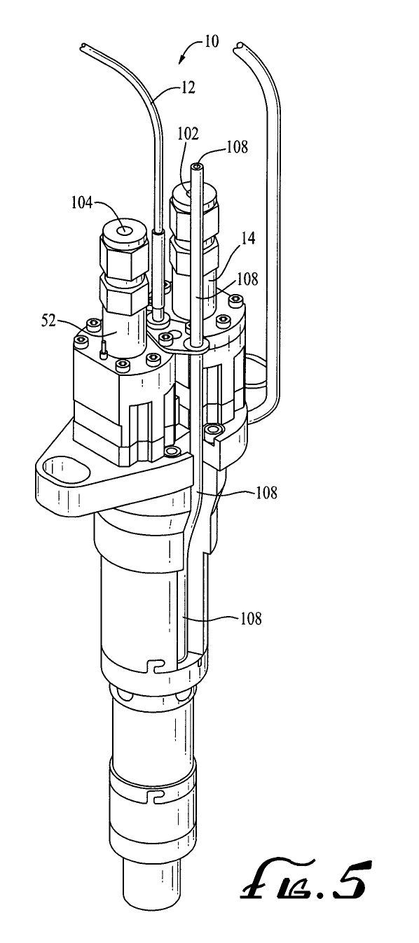

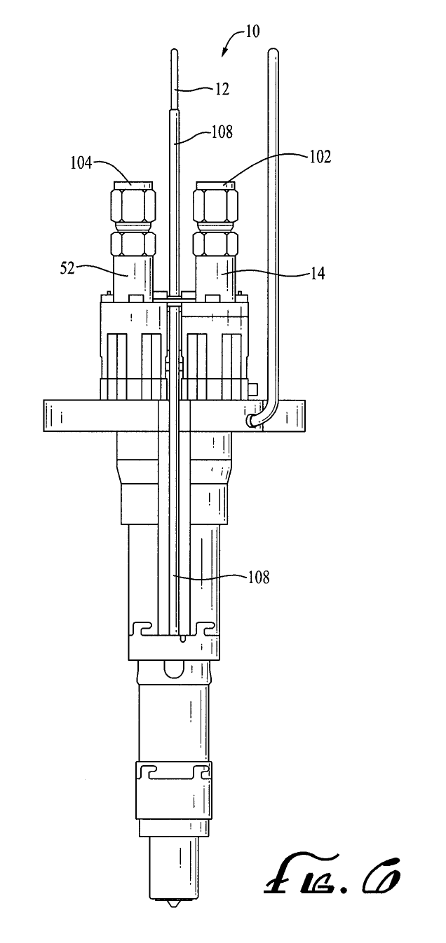

FIG. 5 depicts a front perspective view of the dual solenoid fuel injector 10 depicted in FIG. 2-4. FIG. 6 depicts a front view of the same dual solenoid fuel injector 10. In addition to the components previously described with respect FIG. 2-4, both FIG. 5 and FIG. 6 illustrate fuel duct 108, which supplies pressurized fuel to the input port of the lower fluid chamber 36.

### Actuation of the Injector

When the fuel injector 10 is in a closed state, pressurized fuel is pumped into the lower fluid chamber 36 through the fuel duct 108. The fuel pressure pushes the lower stem 30 upwards and away from the injector seat 38. The upper fluid chamber 44 is also filled with fuel pressurized at substantially the same pressure as the lower fluid chamber 36. The fuel is allowed to flow into the upper fluid chamber 44 by way of the inlet duct 20, which is attached to the input duct 102. When the fluid pressures in the upper fluid chamber 44 and lower fluid chamber 36 are substantially equal and opposite to each other, the injector stem assembly is in a neutral pressure state, allowing the return spring 24 to be the only force acting on the injector stem assembly. Because the return spring 24 exerts a downward force on the injector assembly (as previously discussed), the injector stem assembly is biased closed when the fuel pressure in the upper fluid chamber 44 and the lower fluid chamber 36 are equal.

In order to open the fuel injector 10, the input electromechanical valve 14 is activated, moving the input valve to the “closed” position, while the output electromechanical valve 52 is activated, thereby moving the output valve into the “open” position. When the outlet duct 46 is opened, the fluid in the upper chamber is drained back to a fuel reservoir. Because the pressure in the upper chamber 44 is now released, the pressure in the lower chamber 36 is allowed to push the lower stem 30, and thereby the entire injector stem assembly, in an upward direction away from the injector seat 38 and against the force exerted by the return spring 24. This opens the fuel injector 10, allowing the fuel in the lower chamber 36 to be released from the fuel injector 10 and into the combustion chamber.

To close the fuel injector 10, the input electromechanical valve 14 is deactivated, moving the input valve to the “open” position, while the output electromechanical valve 52 is now deactivated, thereby returning the output valve to the “closed” position. As a result, the inlet duct 20 allows fuel to fill and pressurize the upper chamber 44. The pressurization of the upper fluid chamber 44 along with the force of the return spring 24 pushes the stem assembly downward toward the injector seat 38. The upper and lower fluid chambers (44 and 36) are subsequently allowed to fill with fuel, displacing the injector 10 back into the original closed state.

Thus, it is seen that a dual solenoid fuel injector for an internal combustion engine is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

We claim:

1. A fuel injector for an internal combustion engine comprising:
a housing having an upper and a lower portion;
an injector stem positioned inside the housing, wherein the injector stem comprises a lower portion and an upper portion;
a first fluid chamber for receiving pressurized fuel at the lower portion of the injector stem;
a second fluid chamber for receiving pressurized fuel at the upper portion of the injector stem;
a seal positioned between the first fluid chamber and the second fluid chamber to separate the chambers;
a fuel duct connected to the first fluid chamber;
an input duct connected to the second fluid chamber for allowing fuel to fill the second fluid chamber;
an output duct connected to the second fluid chamber for allowing fuel to drain from the second fluid chamber;
a return spring attached to the injector stem, the return spring biasing the injector stem to a closed position;
a first valve attached to the input duct, the first valve being selectively actuable to open and close the input duct;
a second valve attached to the output duct, the second valve being selectively actuable to open and close the output duct to drain fuel from the second fluid chamber;
a heating element positioned adjacent the first fluid chamber; and
a controller connected to the heating element, the first valve, and the second valve for selective actuation of the heating element, the first valve, and the second valve.

2. The fuel injector according to claim 1, wherein the lower portion of the injector stem comprises a lower injector stem assembly, the upper portion of the injector stem comprises an upper injector stem assembly, and the lower injector stem assembly and the upper injector stem assembly are attached to each other.

3. The fuel injector according to claim 1, wherein the lower portion of the injector stem includes an injector pin configured to contact a seating surface, such that when injector pin is in contact with the seating surface, fuel is prevented from entering a combustion chamber of the internal combustion engine, and when the injector pin is not in contact with the seating surface, fuel enters the combustion chamber.

4. The fuel injector according to claim 1, wherein the first valve is an electromechanical valve.

5. The fuel injector according to claim 4, wherein the electromechanical valve comprises a solenoid for selectively actuating the electromechanical valve, and the solenoid is connected to the controller.

6. The fuel injector according to claim 1, wherein the second valve is an electromechanical valve.

7. The fuel injector according to claim 6, wherein the electromechanical valve comprises a solenoid for selectively actuating the electromechanical valve, and the solenoid is connected to the controller.

8. The fuel injector according to claim 1, wherein fuel within the first fluid chamber is maintained at a supercritical state.

9. The fuel injector according to claim 1, wherein the first fluid chamber has an inner sidewall containing a catalyst.

10. The fuel injector according to claim 1, wherein the lower portion of the injector stem has a catalyst attached thereto.

11. The fuel injector according to claim 1, wherein the first fluid chamber has an inner sidewall containing a catalyst and the lower portion of the injector stem has a catalyst attached thereto.

12. The fuel injector according to claim 8, wherein the supercritical state of the fuel in the first fluid chamber is a supercritical temperature or supercritical pressure.

13. The fuel injector according to claim 12, wherein the heating element heats fuel within the first fluid chamber to the supercritical temperature.

14. The fuel injector according to claim 12, wherein the injector stem in conjunction with the fuel duct maintain fuel within the first fluid chamber at the supercritical pressure.

15. The fuel injector according to claim 1, wherein a proximity sensor connected to the controller is positioned in the upper portion of the housing for monitoring a position of the injector stem.
